(19) United States
(12) Patent Application Publication
(10) Pub. No.: US 2025/0223419 A1
(43) Pub. Date: Jul. 10, 2025

(54) RECYCLED THERMOPLASTIC POLYESTER ELASTOMER AND MANUFACTURING METHOD THEREOF

(71) Applicant: SHINKONG SYNTHETIC FIBERS CORPORATION, TAIPEI CITY (TW)

(72) Inventors: YEN-HAO TSENG, TAIPEI CITY (TW); PO-HAO HUANG, TAIPEI CITY (TW); HUI-MING SU, TAIPEI CITY (TW); CHIU-YEN CHEN, TAIPEI CITY (TW)

(21) Appl. No.: 18/623,904

(22) Filed: Apr. 1, 2024

(30) Foreign Application Priority Data
Jan. 4, 2024 (TW) 113100361

(51) Int. Cl. C08J 11/24; C08G 63/183; C08G 63/85

(52) U.S. Cl. CPC C08J 11/24; C08G 63/183; C08G 63/85; C08J 2367/02

(57) ABSTRACT

A method for manufacturing recycled thermoplastic polyester elastomer (rTPEE), including one-step alcoholysis and transesterification with a polyol-coordinated titanium compound catalyst to obtain recycled polyester, and then reacting with polyol to obtain a recycled thermoplastic polyester elastomer. A recycled thermoplastic polyester elastomer with more excellent hue and better physical properties is provided by using the method.

### FIELD OF INVENTION

The present invention relates to a regenerated thermoplastic polyester elastomer with excellent hue and good physical properties, and a method for manufacturing thereof.

### BACKGROUND

Regenerated thermoplastic elastomer (rTPEE) is produced by the reaction of recycled polyesters and polyols. As compared to polyesters formed from monomers as reaction raw materials, polyesters obtained through recycling would cause decline in performance of regenerated thermoplastic elastomers owing to their technical limitation of recycling. The regenerated products may only be used in low-end fields and cannot be recycled multiple times.

At present, the recycling methods of polyethylene terephthalate (hereinafter referred to as “PET”) mainly include two recycling methods: physical recycling and chemical recycling. The physical recycling method mainly involves directly blending and granulating waste polyester and its products, and cutting recycled resin into slices for use. However, due to the large fluctuations in the quality of recycled resin slices, generally only conventional short fiber products can be produced, and therefore cannot meet the needs of high-end products. The chemical methods include hydrolysis, methanol alcoholysis, ethylene glycol alcoholysis, 1,4-butanediol alcoholysis, microwave method, etc. However, due to the reasons of high recycling costs and technical requirements, recycled waste ester is not widely used to make regenerated thermoplastic elastomers.

Chinese Patent Publication No. CN106113319A discloses a method of obtaining regenerated polyester by filtering the treated polyester waste with ethylene glycol to complete multiple steps of alcoholysis, esterification, and condensation polymerization. U.S. Patent Publication No. US20070225474A1 discloses a method of using ethylene glycol/methanol to depolymerize ethylene terephthalate (PET) into purified terephthalic acid (PTA). Due to the complexity of the process and the consumption of a large amount of organic solvent and energy, it is difficult to commercialize the method using PET as a monomer raw material. European Patent Publication No. EP1437377B1 discloses a method of using 1,4-Butanediol (BDO) to depolymerize PET into intermediate Bis-2-Hydroxybutyl Terephthalate (BHBT) at a high temperature of 200˜260° C., which is then added with polyol raw materials for polymerization to make regenerated thermoplastic elastomer (rTPEE). Compared to traditional PET depolymerization into PTA monomers which are then used as raw material, it is more energy-saving but still comprises at least two steps of depolymerization and esterification. The two-step process is too complicated and tedious.

The preparation of regenerated thermoplastic elastomers disclosed by the prior art in the past all requires depolymerizing PET and then performing a transesterification reaction (i.e., a double-tank reaction) before polymerization, as described in U.S. Patent No. U.S. Pat. No. 7,795,320. However, the preparation method is carried out in two steps, and is not efficient and economic. Chinese Patent Publication No. CN102675113A discloses that a common depolymerization catalyst, zinc acetate, should be added at 0.5˜1.5 wt. % of recycled polyester to achieve good depolymerization effect. However, due to the large amount of this catalyst added, zinc ions remaining in the system would lead to large side reactions during polymerization, limited growth of the molecular chain of the polymer, and poor quality of recycled polyester, as described in Chinese Patent Publication No. CN101531773A and CN107652423B. U.S. Patent Publication No. US20110178265A1 discloses that the titanium catalyst is used in a small amount in the depolymerization step. However, due to the vigorous side reactions during the transesterification polymerization reaction, the ester particle products are prone to yellowing. On the other hand, Chinese Patent Publication No. CN102164985A discloses that since esterification reaction catalysts are generally unstable when being exposed to water, a mannitol-modified titanium catalyst may be used for esterification polymerization and reducing yellowness, but its use is still limited to esterification reactions.

Since the steps of alcoholysis recovery of polyester and esterification by reaction with polyol still need to be carried out separately in two steps, the energy loss of reactor change is extremely large, and the properties required by the catalysts of the two reactions are not the same, resulting in the residues of the catalysts and thereby failing to satisfy the requirement for the yellowness and physical properties of the final products. Therefore, there is still a need for a simple step method of manufacturing regenerated plastic elastomers by applying catalysts of two reaction systems simultaneously.

### SUMMARY

The present invention provides a method for manufacturing a regenerated thermoplastic elastomer using a depolymerization and transesterification dual-use catalyst systems and a thermoplastic elastomer manufactured using the catalyst, which can directly reduce the energy loss of changing reactors. The catalyst has minimal side reactions and does not need to be removed to directly complete the process in one step. Furthermore, by using the catalyst, regenerated thermoplastic elastomers with more excellent hue and physical properties.

One embodiment of the present invention provides a method for manufacturing a regenerated thermoplastic elastomer, comprising the following steps:
a) performing one-step reaction of alcoholysis of a first polyester and transesterification of a second polyol by using a first polyol coordinated titanium compound catalyst; and
b) recovering the second polyester obtained from the one-step reaction of alcoholysis and transesterification.

The method of the present invention further comprises a step:
c) adding about 20 wt. % to about 80 wt. % of a polyol polymer for reaction to obtain a regenerated thermoplastic elastomer.

### BRIEF DESCRIPTION OF DRAWINGS

From the following detailed description of the preferred embodiments of the present invention, the above and other technical features and advantages of the present invention will be more clearly understood by referring to the accompanying drawings.

FIG. 1 depicts a flowchart showing reaction steps according to the embodiments of the present invention.

FIG. 2 depicts a differential scanning calorimetry diagram (DSC) of the rTPEE produced from the embodiments of the present invention as compared to the rTPEE produced from other alcoholysis depolymerization catalyst systems, and the TPEE standard products.

### DETAILED DESCRIPTION

Each of the embodiments and aspects of the present invention will be described in more detail below. The inventions claimed herein may be embodied in different forms and should not be understood as not being limited to the embodiments set forth herein. Instead, the present invention is intended to encompass the alternatives, modifications and equivalents that can be included within the spirit and scope of the embodiments described in the appended claims.

Any numerical value such as concentration or concentration range described herein should be understood as being modified by the term “about” in all instances. The term “about” means within the acceptable error range of a particular value as determined by one of ordinary skill in the art, which will depend in part on how the value is measured or determined, i.e., the limitations of the measurement system. Unless otherwise explicitly stated in the examples or elsewhere in the specification in the context of a particular assay, result or embodiment, the term “about” means within one standard deviation per the practice in the art, or a range up to 5%, whichever is greater.

Reference to “one embodiment”, “an embodiment”, “some embodiments”, etc. indicates that the described embodiments may comprise specific features, structures, aspects or characteristics, but each embodiment may not necessarily comprise such specific features, structures or characteristics. Furthermore, such phrases do not necessarily refer to the same embodiment. In addition, wherein a specific feature, structure or characteristic is described with respect to an embodiment, it is considered herein that, whether explicitly described or not, it is within the knowledge of a person having ordinary skill in the art and therefore such features, structures or characteristics may be implemented with respect to other embodiments.

All technical and scientific terms described in the specification and claims, unless otherwise defined, have definitions that can be understood by a person with ordinary skill in the art to which the present disclosure pertains. The singular terms “a”, “an”, “the”, or similar terms, unless otherwise stated, may refer to more than one object. The words “or”, “and” used in the specification refer to “or/and” unless otherwise stated. In addition, the terms “comprise”, “comprising”, “include”, and “including” are not restrictive open-ended transitional phrases. The foregoing definitions only illustrate the reference of the definitions of terms and should not be considered as limitations on the subject matter. Unless otherwise stated, the materials used in this disclosure are commercially available and readily available.

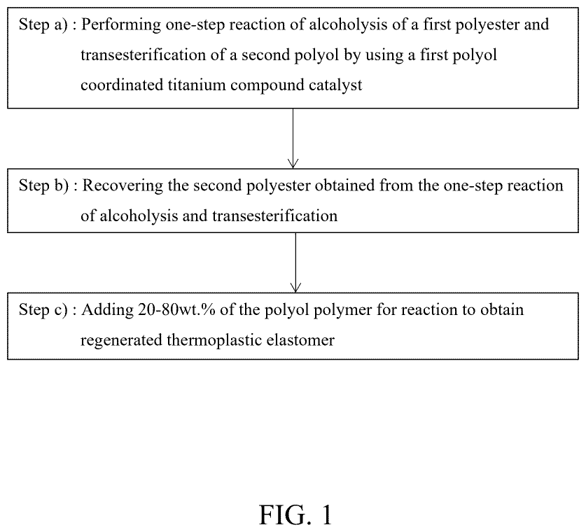

FIG. 1 depicts a flowchart showing the present invention uses a special coordination-modified titanium catalyst to perform one-step alcoholysis to recover polyester and react with polyol for esterification to obtain a regenerated thermoplastic elastomer. It is mainly divided into three steps:
a) performing one-step reaction of alcoholysis of a first polyester and transesterification of the second polyol by using a first polyol coordinated titanium compound catalyst; and
b) recovering the second polyester obtained from the one-step reaction of alcoholysis and transesterification; and
c) adding about 20 wt. % to about 80 wt. % polyol polymer for reaction to obtain regenerated thermoplastic elastomer.

The polyester of the present invention includes, but is not limited to, polyethylene terephthalate (PET), polytrimethylene terephthalate (PTT), polybutylene terephthalate (PBT), polycyclohexylenedimethylene terephthalate (PCT), poly(ethylene 2,6-naphthalate) (PEN) and polyethylene-1,2-bis(2-chlorophenoxy) ethane-4,4′-dicarboxylate, etc. The polyesters that may be depolymerized using the catalyst system disclosed in the present invention are all within the scope of the present invention.

The self-made polyol coordination modified titanium compound catalyst is used in the present invention, and it is optionally further reacted with alkali to improve stability in water, which can be used to depolymerize a polyester and then esterified to prepare a regenerated thermoplastic elastomer. The regenerated thermoplastic elastomer has an excellent hue b* value, and its melting point is close to the TPEE made directly from PTA monomers as raw materials, showing that there are no other excess components remaining in the ester particles.

The polyol coordination modified titanium compound catalyst of the present invention refers to the polymer product with darker color obtained by the use of polyols for coordination to protect titanium atoms, avoiding the reaction of by-products in the esterification reaction with water to form titanium dioxide polymers which leads to deactivation of the catalyst, and delay of the esterification reaction.

The polyol coordination modified titanium compound catalyst of the present invention is prepared by using a titanium compound and a polyol in a molar ratio of about 1:1 to about 1:3, and optionally further using a titanium atom and a base in a molar ratio of about 1:1 to about 100:1 for reaction to enhance its stability in water. In one embodiment, the titanium compound may be tetramethoxy titanium (TMT), tetraethoxy titanium (TET), tetraisopropoxy titanium (TPT), and tetrabutoxy titanium (TBT), etc., among which tetramethoxy titanium and tetraisopropoxy titanium are preferred. The first polyol may be xylitol, sorbitol, maltitol, erythritol, and mannitol, etc., among which mannitol is preferred. In addition, the base used may be an amine compound or an alkali metal compound, specifically lithium hydroxide, sodium hydroxide, amine hydroxide, tetrabutyl amine hydroxide, lithium carbonate, sodium carbonate, potassium carbonate, lithium acetate, sodium acetate, potassium acetate, amines, and triethyl amine, etc., among which lithium hydroxide or sodium hydroxide is preferred. The catalyst prepared in the present invention has high polymerization activity, and the regenerated thermoplastic elastomer obtained by the process using this catalyst possesses a fine hue.

Through the following non-limiting embodiments, the followings are described in more detail: the method for manufacturing the polyol-modified titanium catalyst system, and the method for manufacturing regenerated thermoplastic elastomers by the use of the catalyst in one-step reaction of alcoholysis depolymerization and esterification to recover waste ester which is further reacted with polyol.

### Catalyst Preparation:

### Examples 1-5: Preparation of Mannitol Coordination Modified Titanium Catalyst

The titanium catalyst of Example 1 was prepared by adding 110 kg of 1,4-butanediol and 3 kg of mannitol to the reaction tank, which were heated to 80° C. for 30 minutes for reaction. The mixture was cooled to 45° C. and reacted for 6 hours. 4.5 kg of titanium isopropoxide was added and reacted for 1 hour to complete the manufacture of the mannitol coordination modified titanium catalyst with a titanium content of 0.6 wt. %. In Examples 2 to 5, the added amount of the mannitol coordination modified titanium catalyst was adjusted. The mannitol coordination modified titanium catalysts (TC1˜5) at different concentrations for use in the examples of one-step reaction of alcoholysis and esterification were obtained, as shown in Table 1 below.

TABLE 1

| | Catalyst | Content of catalyst (mmole %) |
|---|---|---|
| Example 1 | TC1 | 0.012 |
| Example 2 | TC2 | 0.024 |
| Example 3 | TC3 | 0.036 |
| Example 4 | TC4 | 0.048 |
| Example 5 | TC5 | 0.06 |

### Comparative Examples 1-4

Catalysts used in Comparative Examples 1-4 are depolymerization catalysts (i.e., titanium butoxide and zinc acetate) at different concentrations, as shown in Table 2 below.

TABLE 2

| | | Content of catalyst |
|---|---|---|
| | Catalyst | (mmole %) |
| Comparative Example 1 | titanium butoxide | 0.024 |
| Comparative Example 2 | titanium butoxide | 0.048 |
| Comparative Example 3 | zinc acetate | 0.024 |
| Comparative Example 4 | zinc acetate | 0.048 |

Production of rTPEE: One-Step Reaction of Alcoholysis and Transesterification

### Standard Example

18 kg of PTA, 8.5 kg of 1,4-butanediol, 11 kg of polytetrahydrofuran ether (molecular weight 1800 g/mol), 16 kg of polyethylene glycol (molecular weight 2000 g/mol), 0.024 mmol of titanium butoxide as catalyst were added to the alcoholysis/transesterification reaction tank under the reaction temperature of 220° C., and the reaction pressure of 1 atm, for the reaction time of 6 hours. The transesterified product was transferred to the polymerization reaction tank, to which 90 g of antioxidant Irganox® 1010 and 34 g of titanium butoxide were added, and the temperature was elevated to 245° C., the pressure was reduced to less than 1 torr, and the mixture was allowed to react for 3 to 4 hours. After reaching the set mechanical torque value, the polymerization reaction tank was depressurized to a normal pressure, the discharge part was opened to let the ester strips cooled through the water channel, which were then cut into pellets by using a pelletizer to obtain the regenerated thermoplastic elastomer.

### Example 1

18 kg of recycled PET, 8.5 kg of 1,4-butanediol, 11 kg of polytetrahydrofuran ether (molecular weight 1800 g/mol), 16 kg of polyethylene glycol (molecular weight 2000 g/mol), and the mannitol coordination modified titanium catalyst (as the catalyst with the concentration prepared according g to Example 1 illustrated above) were added to the alcoholysis/transesterification reaction tank under the reaction temperature of 220° C., and the reaction pressure of 1 atm, for the reaction time of 6 hours. The transesterified product was transferred to the polymerization reaction tank, to which 90 g of antioxidant Irganox® 1010 and 34 g of titanium butoxide were added, and the temperature was elevated to 245° C., the pressure was reduced to less than 1 torr, and the mixture was allowed to react for 3 to 4 hours. After reaching the set mechanical torque value, the polymerization reaction tank was depressurized to a normal pressure, the discharge part was opened to let the ester strips cooled through the water channel, which were then cut into pellets by using a pelletizer to obtain the regenerated thermoplastic elastomer having the physical properties shown in Table 3 below.

### Examples 2-5

Following the same steps of Example 1 as described above, only the mannitol coordination titanium catalyst (as shown in Table 1) was changed to be added at different concentrations. In addition, under the same reaction conditions, the regenerated thermoplastic elastomer was obtained and its physical properties are shown in Table 3 below.

### Comparative Examples 1-4

Following the same steps of Example 1 as described above, only different catalysts/amounts (as shown in Table 2) added were changed. In addition, under the same reaction conditions, the regenerated thermoplastic elastomer was obtained and its physical properties are shown in Table 3 below.

### Physical Properties of Thermoplastic Elastomers:

The methods of measurement for physical properties of thermoplastic elastomer standard products and regenerated thermoplastic elastomers are shown as below:

### Intrinsic Viscosity

According to the measurement method ASTM D-2857, a minute amount of a sample is completely dissolved in tetrachloromethane, the flow rate of the solution is measured, and the intrinsic viscosity of the object to be measured is obtained in dl/g.

### Hue

According to the measurement method ASTM D2244, the L*a*b* color model formulated by CIE is used as the standard for measuring color. The L*a*b* color model consists of three elements, wherein L* represents lightness, L*=0 is black, L*=100 is white; a* represents the position between red/green, wherein a negative value of a* indicates green, while a positive value of a* indicates red; the b* value represents the position between yellow/blue, wherein a negative value of b* indicates blue, while a positive value of b* indicates yellow. Therefore, in Table 2 below, a colorimeter is used to measure the hue b* of the object to be tested, as an indicator of reduction of the yellowing degree.

### Melting Point

According to the measurement method ASTM E-794, differential scanning calorimetry (DSC) is used to obtain the melting point of the object to be measured. The basic principle is that when the sample undergoes phase change, glass transition and chemical reaction, it will absorb and releasing heat, the compensator can measure how to increase or decrease the heat flow to keep the temperatures of sample and reference consistent. Therefore, in Table 3 below, a differential scanning calorimeter is used to obtain the melting point of the object to be measured, as an indicator for comparison with the physical properties of the TPEE standard product.

The physical properties of the thermoplastic elastomers of Examples 1-5, Comparative Examples 1-4 and Standard Example measured according to the above methods are as shown in Table 3:

TABLE 3

| | | | Polymerization | Intrinsic | | Melting |
|---|---|---|---|---|---|---|
| | PET | | time | viscosity | Hue | point |
| | material | Catalyst | (min) | (dl/g) | (b*) | (° C.) |
| Standard | PTA | titanium | 135 | 1.87 | +7.3 | 171 |
| Example | | butoxide | | | | |
| Example 1 | recycled | TC1 | 135 | 1.86 | +8.0 | 166 |
| Example 2 | PET | TC2 | 120 | 1.83 | +8.3 | 167 |
| Example 3 | | TC3 | 115 | 1.85 | +8.4 | 168 |
| Example 4 | | TC4 | 105 | 1.88 | +8.8 | 170 |
| Example 5 | | TC5 | 100 | 1.85 | +9.2 | 170 |
| Comparative | | titanium | 130 | 1.81 | +9.5 | 166 |
| Example 1 | | butoxide | | | | |
| Comparative | | titanium | 120 | 1.85 | +10.2 | 168 |
| Example 2 | | butoxide | | | | |
| Comparative | | zinc | 135 | 1.79 | +8.9 | 160 |
| Example 3 | | acetate | | | | |
| Comparative | | zinc | 125 | 1.82 | +9.2 | 165 |
| Example 4 | | acetate | | | | |

The regenerated thermoplastic elastomer (rTPEE) obtained from the above Examples and Comparative Examples, as compared to the TPEE standard product of the Standard Example, it can be seen that the titanium catalysts modified by the polyol coordination used in the present invention can undergo alcoholysis depolymerization and transesterification in one-step reaction, and can be used to produce higher-quality regenerated thermoplastic elastomers as compared to the conventional catalysts. The intrinsic viscosity, hue, and melting point of the products are all closer to the TPEE standard, indicating that there is no excess other components formed by side reactions in the ester particles.

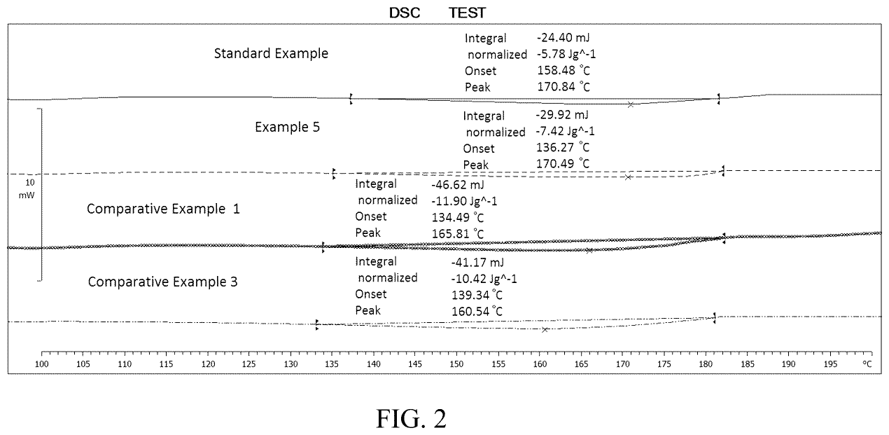

As shown in FIG. 2, the differential scanning calorimetry (DSC) diagram of the rTPEE produced by the examples of the present invention, and the rTPEE produced by other alcoholysis depolymerization catalyst systems and the TPEE standard product shows that as compared to the comparative examples, the Examples of the present invention have a rTPEE characteristic pattern closer to the TPEE standard, indicating that they have fewer impurities, higher purity and physical properties closer to the TPEE standard.

The intrinsic viscosity of the regenerated thermoplastic elastomer mainly affects its flow properties during use, such as spinning, film coating or injection molding. Due to the influence of its use, the intrinsic viscosity is preferably 1.83˜1.9 dl/g, and most preferably 1.85˜1.9 dl/g. Hue mainly affects the visual appearance during use, and yellowing will also cause degradation of properties. The hue b* is preferably +7˜+9.2, and most preferably +7˜+8.5. The melting point mainly affects the control of the processing temperature and physical properties such as heat resistance, and the melting point is preferably 166˜171° C., and most preferably 168˜171° C.

Since the present invention uses a special coordination-modified titanium catalyst to perform one-step alcoholysis/esterification to recover polyester which is reacted with polyols for esterification to obtain a regenerated thermoplastic elastomer, its intrinsic viscosity, hue b*, and melting point can all be controlled within appropriate ranges simultaneously and the quality requirements of the recycled thermoplastic elastomer can be satisfied. Therefore, the present invention provides an economical and high quality manufacturing method for regenerated thermoplastic elastomers.

For the purpose of explanation, the foregoing descriptions use specific nomenclature to provide a thorough understanding of the described embodiments. However, a person having ordinary skill in the art will understand that many specific details are not required in order to practice the described embodiments. Accordingly, the foregoing descriptions of the specific embodiments described herein are presented for the purposes of illustration and description. It is not intended to be exhaustive or to limit the embodiments to the precise forms disclosed. Therefore, a person having ordinary skill in the art will appreciate that many modifications and variations are possible in light of the above teachings.

The Summary and Abstract paragraphs may set forth one or more, but not all, exemplary embodiments of the invention as contemplated by the invention, and they are not intended to limit the scope of the invention and the accompanying claims in any way.

The foregoing descriptions of specific embodiments will fully disclose the general nature of the invention so that the others can easily modify and/or adapt it to various embodiments by applying the knowledge in the art without undue experimentation and without departing from the general concept of the invention. Therefore, such adaptations and modifications are intended to be within the meaning and scope of equivalents of the disclosed embodiments, based on the teachings and guidance presented herein. It should be understood that the terminology and expression used herein are for the purpose of explanation rather than limitation, and are to be interpreted by a person having ordinary skill in the art in view of the teachings and guidance. The breadth and scope of the present invention should not be limited by any of the above-described illustrative embodiments, but should be defined solely in accordance with the following claims and the equivalents thereof.

The invention claimed is:

1. A method for manufacturing a recycled thermoplastic elastomer, comprising steps:
a) performing one-step reaction of alcoholysis of a first polyester and transesterification of a second polyol by using a first polyol coordinated titanium compound catalyst; and
b) recovering the second polyester obtained from the one-step reaction of alcoholysis and transesterification.

2. The method of claim 1, wherein the coordination ratio of the titanium compound catalyst the first polyol to is about 1:1 to about 3:1.

3. The method of claim 1, wherein the first polyol is selected from the group consisting of xylitol, sorbitol, maltitol, erythritol and mannitol.

4. The method of claim 1, wherein the first polyol coordinated titanium compound catalyst is prepared by adding an alkali metal salt for reaction.

5. The method of claim 1, wherein the first polyol coordinated titanium compound catalyst is prepared in alcohol/water solvent system for reaction.

6. The method of claim 1, wherein the first polyol coordinated titanium compound catalyst is prepared by reacting at a reaction temperature of about 0° C. to about 100° C.

7. The method of claim 1, wherein the first polyol coordinated titanium compound catalyst is prepared by reacting in a reaction time of about 2 hours to about 8 hours.

8. The method of claim 1, wherein the first polyol coordinated titanium compound catalyst is added in an amount of about 0.01 mmol to about 1 mmol.

9. The system of claim 1, wherein the first polyester is selected from the group consisting of polyethylene terephthalate (PET), polytrimethylene terephthalate (PTT), polybutylene terephthalate (PBT), polycyclohexylenedimethylene terephthalate (PCT), poly(ethylene 2,6-naphthalate) (PEN) and polyethylene-1,2-bis(2-chlorophenoxy) ethane-4,4′-dicarboxylate.

10. The method of claim 1, wherein the second polyol is selected from the group consisting of ethylene glycol, propylene glycol and butylene glycol.

11. The method of claim 1, wherein the first polyester is selected from the group consisting of polyethylene terephthalate (PET), polytrimethylene terephthalate (PTT) and polybutylene terephthalate (PBT).

12. The method of claim 1, wherein the reaction temperature of step a) is about 190° C. to about 240° C.

13. The method of claim 1, wherein the reaction pressure of step a) is about 1 atm to about 2.5 atm.

14. The method of claim 1, wherein the reaction time of step a) is about 2 hours to about 8 hours.

15. The method of claim 1, further comprising a step:
c) adding about 20 to about 80 wt. % of a polyol polymer for reaction to obtain a regenerated thermoplastic elastomer.

16. The method of claim 15, wherein the carbon number of the polyol polymer in step c) is 2 to 7.

17. The method of claim 15, wherein the molecular weight of the polyol polymer in step c) is about 200 to about 10,000 g/mol.

18. The method of claim 15, wherein the reaction temperature of step c) is about 220 to about 280° C.

19. The method of claim 15, wherein the reaction pressure of step c) is less than about 1 atm.

20. The method of claim 15, wherein the reaction time of step c) is about 2 hours to about 6 hours.

21. The method of claim 15, wherein step c) further comprises adding about 0.5 wt. % to about 5 wt. % of an additive.

22. The method of claim 15, wherein the additive is selected from the group consisting of an antioxidant, an ultraviolet absorber and a cross-linking agent.

23. A regenerated thermoplastic elastomer prepared by the method according to claim 1.
